(19) United States
(12) Patent Application Publication
(10) Pub. No.: US 2016/0119489 A1
(43) Pub. Date: Apr. 28, 2016

(54) IMAGE FORMING SYSTEM AND IMAGE FORMING METHOD

(71) Applicant: KYOCERA Document Solutions Inc., Osaka (JP)

(72) Inventor: Toshiaki Ueno, Osaka (JP)

(21) Appl. No.: 14/918,584

(22) Filed: Oct. 21, 2015

(30) Foreign Application Priority Data
Oct. 24, 2014 (JP) 2014-216866

(51) Int. Cl. H04N 1/00; G06F 3/12

(52) U.S. Cl. CPC H04N 1/00204; G06F 3/121; G06F 3/1211; G06F 3/1267; G06F 3/1274; G06F 3/1294; H04N 2201/0094

(57) ABSTRACT

An image forming system includes a terminal device and an image forming device. The image forming device includes a file returning unit that returns a PDL file of a print job to the source terminal device which had sent the print job as a comparison PDL file through a network. The terminal device includes a file transmitting unit that temporarily stores the PDL file of the print job in a first memory as a reference PDL file on transmission of the PDL file of the print job to the image forming device through the network, a file judging unit that judges whether or not the comparison PDL file returned from the image forming device matches with the reference PDL file, and a file storing unit that stores the comparison PDL file in the first memory if the comparison PDL file does not match with the reference PDL file.

### INCORPORATION BY REFERENCE

The disclosure of Japanese Patent Application No. 2014-216866 filed on Oct. 24, 2014 including the specification, drawings and abstract is incorporated herein by reference in its entirety.

### BACKGROUND

The present disclosure relates to an image forming system and an image forming method.

In recent years, image forming systems in which terminal devices preparing a print job are connected to image forming devices, such as printers, copying machine, and multi function peripherals, through communication cables, has been introduced in many offices. These image forming systems utilize various techniques for improving the convenience of users.

For example, an image processing device is known which analyzes drawing commands written in a memory, and then writes image data after gradation processing in the memory. This device has a drawing command analyzing means which analyzes drawing commands and a drawing command table in which all the drawing commands are registered. Furthermore, the device has an error processing command storing means in which an error processing command has stored and an error processing executing means that executes the error processing command stored in the error processing command storing means to execute error processing when the drawing command analyzing means detects a command error in which the drawing command read from the memory is not registered in the drawing command table. According to this technique, even when a writing error occurs in the memory from which drawing processing is read, printing of an unusual image can be suppressed.

Alternatively, an image forming device is known in which, when an analyzing unit analyzes image data received by a receiving unit, and then an analysis error, such as a grammatical error of a command, occurs during the analysis in a dump mode, a dump processing unit stores data around the position where the analysis error is recognized in a predump buffer and an error dump buffer. In this device, the stored data are output as a dump list by an image processing unit. Then, on the output of the dump list, the dump list is output with a mark attached to the position where the analysis error has occurred. According to this technique, when the analysis error is recognized, the dump list of a peripheral portion of the position where the error has occurred can be output in order to quickly find the cause of the analysis error.

### SUMMARY

An image forming system according to one aspect the present disclosure is an image forming system including a terminal device and an image forming device. The image forming device includes a file returning unit. The terminal device includes a file transmitting unit, a file judging unit, and a file storing unit. The file returning unit returns a PDL file of a print job received from a sender terminal device, which had sent the print job, to the sender terminal device as a comparison PDL file through a network. The file transmitting unit temporarily stores the PDL file of the print job in a first memory as a reference PDL file when the PDL file of the print job is transmitted to the image forming device through the network. The file judging unit judges whether or not the comparison PDL file returned from the image forming device matches with the reference PDL file. The file storing unit stores the comparison PDL file in the first memory if the comparison PDL file does not match with the reference PDL file.

An image forming method according to another aspect of the present disclosure is an image forming method employing an image forming system involving a terminal device and an image forming device. The image forming method includes a file transmitting step, a file returning step, a file judging step, and a file storing step. The file transmitting step includes, in the terminal device, temporarily storing a PDL file of a print job in a first memory as a reference PDL file when the PDL file of the print job is transmitted to the image forming device through a network. The file returning step includes, in the image forming device, returning the PDL file of the print job received from a sender terminal device which had sent the print job to the sender terminal device as a comparison PDL file through a network. The file judging step includes, in the terminal device, judging whether or not the comparison PDL file returned from the image forming device matches with the reference PDL file. The file storing step includes, in the terminal device, storing the comparison PDL file in the first memory if the comparison PDL file does not match with the reference PDL file.

### BRIEF DESCRIPTION OF THE DRAWINGS

FIG. 1 is a schematic diagram illustrating the entire configuration of an image forming system according to the present disclosure.

FIG. 2 is a functional block diagram of an image forming system in an embodiment of the present disclosure.

FIG. 3 is a flow chart for illustrating the execution procedure of the embodiment of the present disclosure.

FIG. 4 is a schematic diagram of the image forming system when a communication error does not occur in the embodiment of the present disclosure.

FIG. 5 is a schematic diagram of the image forming system when a communication error has occurred in the embodiment of the present disclosure.

### DETAILED DESCRIPTION

Hereinafter, an embodiment of an image forming system and an image forming method of the present disclosure is described with reference to the accompanying drawings for understanding the present disclosure. The embodiment described below is an example of embodying the present disclosure and does not limit the technical scope of the present disclosure. The alphabet S attached before the number in the flow chart means a step.

Hereinafter, an image forming system having a terminal device and an image forming device is described as an example of the embodiment of the present disclosure. As the image forming device of the present disclosure, a multi function peripheral (MFT) having functions of a facsimile, a copy, a scanner, a printer, and the like, a copying machine, a printer, and the like are mentioned, for example.

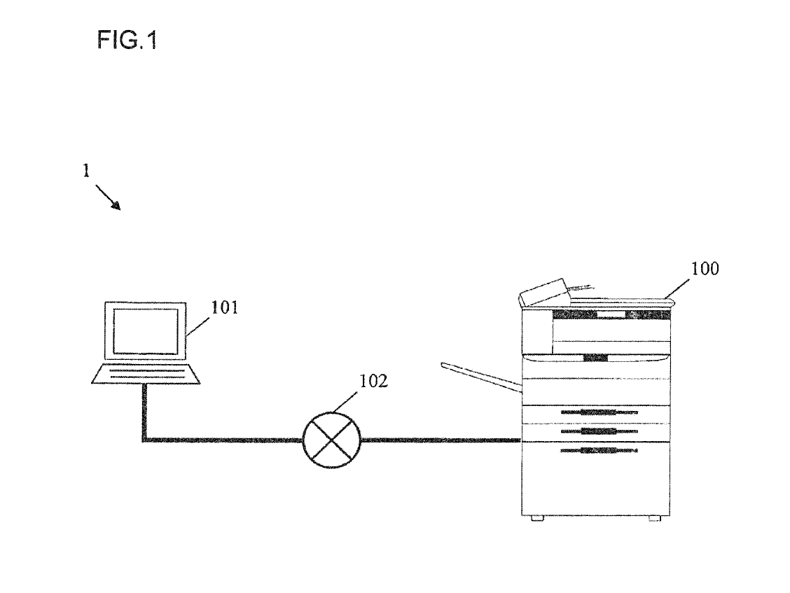

In an image forming system 1, an image forming device 100 and a terminal device 101 are communicatively connected to each other through a network 102, such as a LAN, as illustrated in FIG. 1. When the image forming device 100 receives a print job containing image data of a PDL file, the image forming device 100 executes RIP (Raster Image Processor) processing to the PDL file of the print job to convert the image data to image data of a raster image having a sufficient resolution required for printing. Then, the image forming device 100 executes the print job based on the setting conditions of the print job and the converted image data. The terminal device 101 generates a file (image data) serving as the origin of the PDL file and the setting conditions thereof, and then prepares a print job according to a request from a user. When a predetermined image forming device 100 is specified by a user, the terminal device 101 transmits the print job to the specified image forming device 100. The network 102 may be a wired or wireless network.

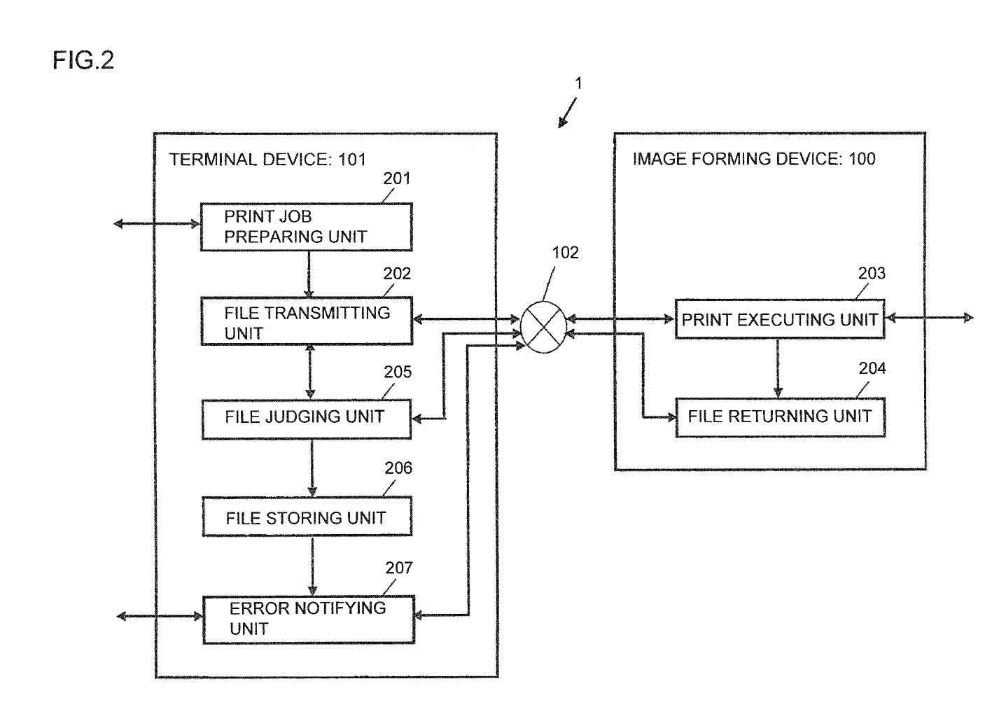

With respect to control circuits of the image forming device 100 and the terminal device 101, drivers corresponding to a CPU (Central Processing Unit), a ROM (Read Only Memory), a RAM (Random Access Memory), and driving units are connected to each other with an internal bus, although not illustrated. The CPU of each of the image forming device 100 and the terminal device 101 utilizes the RAM, for example, as a working space, and then executes programs stored in the ROM and the like. The CPU of each of the image forming device 100 and the terminal device 101 transmits and receives data, directions, signals, commands, and the like from the drivers based on the execution results, and then controls the operation of each driving unit relating to the execution of various kinds of processing. Also with respect to each unit (illustrated in FIG. 2) described later other than the driving units, the units are realized by the execution of programs by the CPU. The ROM and the RAM store programs and data realizing the units described below.

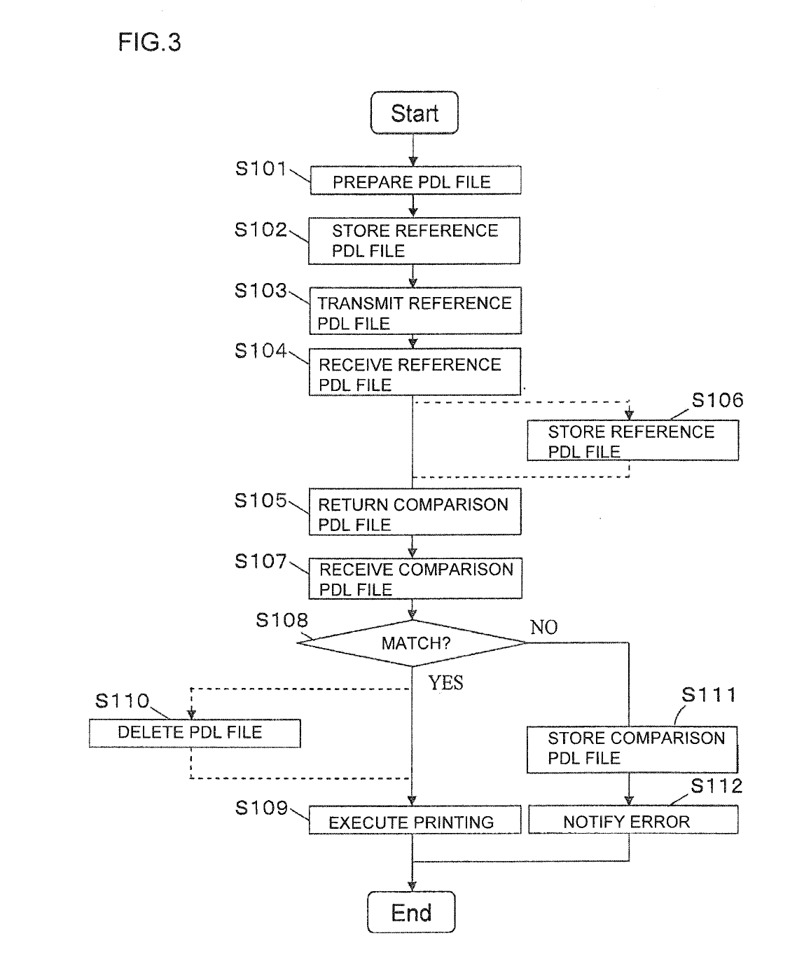

Next, the configuration and the execution procedure according to the embodiment of the present disclosure are described with reference to FIG. 2 and FIG. 3. First, when a user utilizing the terminal device 101 prepares a predetermined document for inputting image data and inputs predetermined setting conditions (for example, Image forming device of a printed matter output destination “Multi function peripheral A”, Paper size “A4”, and the like) through an operation unit of the terminal device 101, a print job preparing unit 201 of the terminal device 101 prepares a print job based on the input image data and setting conditions (FIG. 3: S101).

Then, when the user inputs an execution key (transmission key) of the print job through the operation unit of the terminal device 101, the print job preparing unit 201 of the terminal device 101 receives the input of the execution key to convert image data of the print job to a PDL file, and then notifies the conversion to a file transmitting unit 202. The file transmitting unit 202 that received the notice temporarily stores the PDL file of the print job as a reference PDL file in a first memory provided beforehand in the terminal device 101 (FIG. 3: S102).

In this case, when the file transmitting unit 202 temporarily stores the reference PDL file in the memory, the file transmitting unit 202 gives an identification number which allows the identification of the reference PDL file (or the print job), for example, and then stores the reference PDL file in the first memory. Thus, when a plurality of print jobs are prepared, a specific PDL file can be identified from the identification number.

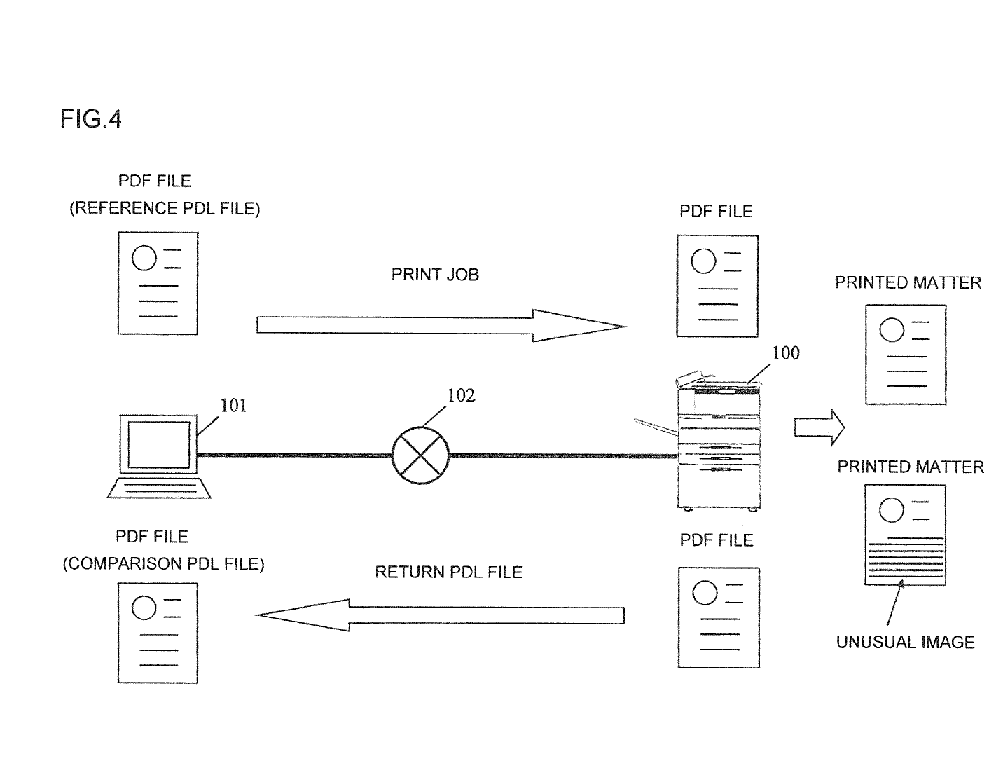

Next, the file transmitting unit 202 transmits the print job attached with the reference PDL file (image data) to the specified image forming device 100 under the setting conditions through the network 102 as illustrated in FIG. 4 (FIG. 3: S103).

On the other hand, when a printing executing unit 203 of the image forming device 100 receives the print job with the PDL file through the network 102 (FIG. 3: S104), the reception of the print job is notified to a file returning unit 204. The file returning unit 204 that received the notice returns the PDL file of the received print job to the sender terminal device 101 which had sent the print job as a comparison PDL file through the network 102 (FIG. 3: S105).

In this case, a way for returning the PDL file by the file returning unit 204 is not particularly limited. For example, the file returning unit 204 may return the reference PDL file, as it is, of the received print job to the terminal device 101 as a comparison PDL file. A configuration may also be acceptable in which, when the reference PDL file is returned, the reference PDL file may be temporarily stored in a second memory provided beforehand in the image forming device 100 (FIG. 3: S106). By temporarily storing the reference PDL file in the second memory, if a communication error on the network 102 occurs during the transmission of the reference PDL file from the terminal device 101 to the image forming device 100, the reference PDL file can serve as a proof that shows the cause of the communication error.

Then, when the terminal device 101 receives the return of the comparison PDL file from the file returning unit 204 of the image forming device 100 (FIG. 3: S107), the return of the comparison PDL file is notified to the file judging unit 205. Then, the file judging unit 205 that received the notice judges whether or not the returned comparison PDL file matches with the reference PDL file temporarily stored in the first memory of the terminal device 101 (FIG. 3: S108).

In this case, a way of judgment by the file judging unit 205 is not particularly limited. For example, the file judging unit 205 judges whether or not the pixel values of pixels of the comparison PDL file and the pixel values of pixels of the reference PDL file match with each other in each pixel, and then, if the pixel values of all the pixels of the comparison PDL file match with the pixel values of all the pixels of the reference PDL file, the file judging unit 205 judges that the comparison PDL file matches with the reference PDL file. This makes it possible to detect the occurrence of a communication error in detail. By judging whether or not the pixel values of all the pixels of the comparison PDL file match with the pixel values of all the pixels of the reference PDL file as described above, a case where the PDL files are grammatically correct and only the pixel values (data) are different from each other, e.g., a case where the color and the length of line segments are unusual, can be detected as garbled data of the PDL file due to a communication error.

As another method, when the file judging unit 205 judges whether or not the pixel values of pixels of the comparison PDL file and the pixel values of pixels of the reference PDL file match with each other in each pixel, the mismatch ratio of the pixels of the comparison PDL file which do not match with the pixel values of the pixels of the reference PDL file to all the pixels of the comparison PDL file is calculated, and then the file judging unit 205 judges whether or not the calculated mismatch ratio exceeds a preset threshold value (for example, 10%). Then, if the mismatch ratio does not exceed the threshold value, the file judging unit 205 may judge that the comparison PDL file matches with the reference PDL file. If the mismatch ratio exceeds the threshold value, the file judging unit 205 may judge that the comparison PDL file does not match with the reference PDL file.

In S108, if the comparison PDL file matches with the reference PDL file as a result of the judgment (FIG. 3: S108 YES), the file judging unit 205 judges that a communication error does not occur, and then notifies the fact to the printing executing unit 203 of the image forming device 100 through the network 102. The printing executing unit 203 that received the notice executes an RIP processing to the PDL file of the print job, and then executes the print job based on the setting conditions of the print job and the image data after the RIP processing (FIG. 3: S109). Thus, if a communication error does not occur, the print job is properly executed.

If the file judging unit 205 judges that the comparison PDL file matches with the reference PDL file, it is preferable for the file judging unit 205 to delete the comparison PDL file and the reference PDL file (including the identification number) stored in the first memory. This makes it possible to avoid wasteful consumption of the storage capacity in the first memory of the terminal device 101.

A way for executing a print job by the printing executing unit 203 is not particularly limited. For example, the printing executing unit 203 simply may execute the print job (FIG. 3: S109) or when the file returning unit 204 temporarily stores the comparison PDL file in the second memory, the printing executing unit 203 may delete the comparison PDL file temporarily stored in the second memory in response to a direction of deleting the comparison PDL file from the file judging unit 205 (FIG. 3: S110), and then may execute the print job (FIG. 3: S109). This makes it possible to avoid wasteful consumption of the storage capacity in the second memory of the image forming device 100.

Then, a case is assumed, in which an unusual image is output in predetermined printed matter after the printing executing unit 203 executes the print job, and then the printed matter is discharged as illustrated in FIG. 4. In this case, the reference PDL file has properly reached the image forming device 100. Thus, the presence of some defect in the image forming device 100 (for example, RIP processing) can be detected, even though there is no reproducibility of the unusual image of the printed matter.

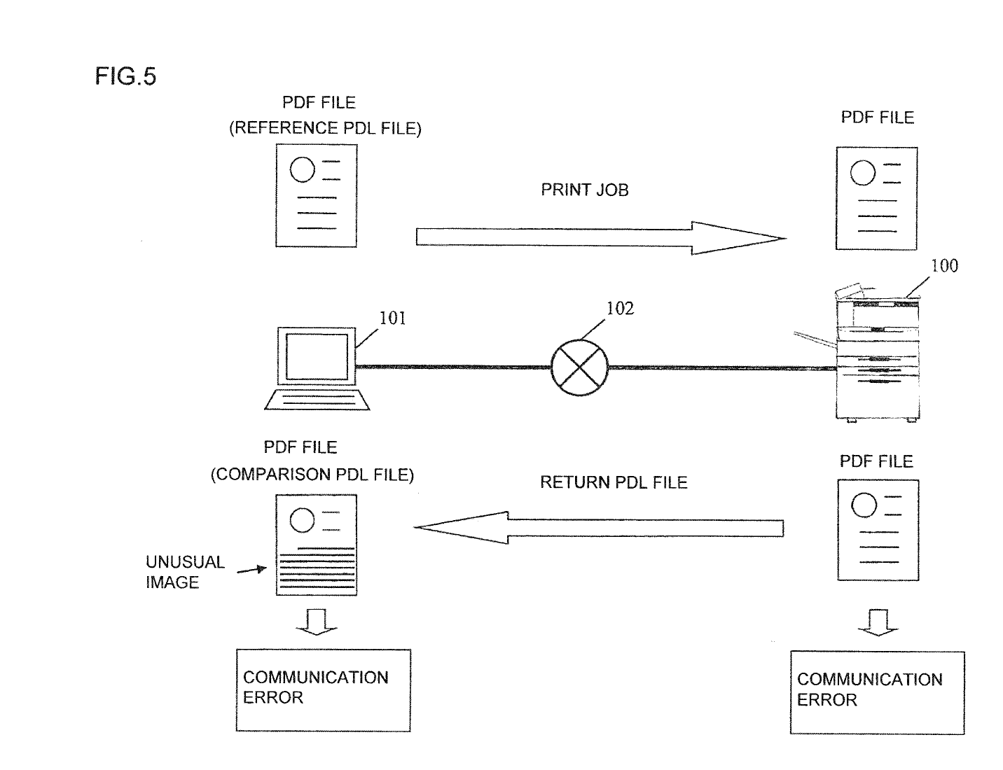

On the contrary, in 5108, when the comparison PDL file does not match with the reference PDL file as a result of the judgment (FIG. 3: S108 NO), a communication error occurs in the network 102 as illustrated in FIG. 5. Then, the file judging unit 205 judges that a communication error has occurred, and then notifies the occurrence of the communication error to the file storing unit 206. The file storing unit 206 that received the notice stores the comparison PDL file in the first memory (FIG. 3: S111).

In this case, it is preferable for the file storing unit 206 to store the comparison PDL file in the first memory with the current date and time. The first memory where the comparison PDL file, the reference PDL file, and the current date and time are to be stored may be a memory (for example, SSD (Solid State Drive)) built in the terminal device 101 or may be a memory (for example, HDD (Hard Disk Drive)) in an external storage. In addition to the comparison PDL file, the reference PDL file, and the current date and time, a file name and an identification number of the print job may be stored. The file storing unit 206 notifies the storage thereof to the file returning unit 204 of the image forming device 100 through the network 102. The file returning unit 204 records the current date and time in the reference PDL file temporarily stored in the second memory of the image forming device 100. This makes it possible to analyze the cause of the communication error by analyzing the PDL file and the date and time stored in the first memory and the second memory in the terminal device 101 and the image forming device 100, respectively. For example, by re-transmitting the reference PDL file stored in the first memory of the terminal device 101 to the image forming device 100 through the network 102 or re-transmitting the reference PDL file stored in the second memory of the image forming device 100 to the terminal device 101 through the network 102, whether or not the same unusual image occurs can be checked, and the absence of any problems in the image forming device 100 or the terminal device 101 can be established.

In particular, since the communication error has low reproducibility, storing all the PDL files relating to the communication error and the date and time thereof is helpful for analyzing the cause of the occurrence of the communication error tracing back to the past. Moreover, by storing all the PDL files relating to the communication error, a reproducibility test of the communication error is easily performed, and therefore the number of times of the reproducibility tests can be sharply reduced.

When the file storing unit 206 completes the storage, the completion of the storage is notified to the error notifying unit 207. Then, the error notifying unit 207 that received the notice notifies the occurrence of the communication error to the terminal device 101 and the image forming device 100 (FIG. 3: S112).

In this case, a way of notification from the error notifying unit 207 is not particularly limited. For example, the error notifying unit 207 urges a user to call a serviceman by displaying a communication error screen on a display portion (for example, liquid crystal display) of the terminal device 101 or displaying a communication error screen on a display portion (for example, touch panel) of the image forming device 100 through the network 102 as illustrated in FIG. 5. Thus, the user can know the occurrence of a communication error. The error notifying unit 207 notifies the occurrence of the communication error to the printing executing unit 203, and then prohibits the execution of the print job of the printing executing unit 203. This makes it possible to prohibit the printing of the PDL file from which an unusual image may be formed. Thus, wasteful consumption of paper and toner can be reduced.

In the embodiment of the present disclosure, the case is assumed where one PDL file is attached to each print job, but the same applies to a case where a plurality of PDL files (for example, 100 pages) are attached to each print job. In this case, the file returning unit 204 returns all the PDL files as comparison PDL files to the terminal device 101 and the file judging unit 205 judges whether or not the received comparison PDL file matches with the reference PDL file stored in the first memory of the terminal device 101 in each PDL file. Then, the printing executing unit 203 executes a print job for the comparison PDL file which matches with the reference PDL file. With respect to the comparison PDL file which does not match with the reference PDL file, the file storing unit 206 stores the comparison PDL file, the reference PDL file, and the current date and time thereof, for example, in the first memory. Thus, among the PDL file having the plurality of pages, some PDL files from which a communication error does not occur can be printed and some PDL files from which an communication error has occurred can be stored, and then the attribute, the form, and the like of the PDL file which may cause a communication error can be analyzed in detail. Moreover, wasteful consumption of the storage area (memory and resource) can also be reduced.

In the embodiment of the present disclosure, the configuration in which each device of the image forming system has each unit is adopted. However, a configuration may also be adopted in which programs realizing the units are stored in a storage medium, and then the storage medium is provided. In the configuration, each program is read by each device, and then each device realizes each unit. In that case, the programs themselves read from the recording medium demonstrate the effects of the present disclosure. Furthermore, it is also possible to provide a method of storing a step executed by each unit in a hard disk.

As described above, the image forming system and the image forming method according to the present disclosure are useful for an image forming system involving an image forming device, such as a multi function peripheral, a copying machine, a printer, and a scanner. Furthermore, they are effective as an image forming system and an image forming method capable of specifying a communication error without wastefully consuming a storage area.

What is claimed is:

1. An image forming system comprising:
a terminal device; and
an image forming device, wherein
the image forming device includes
a file returning unit that returns a PDL file of a print job received from a sender terminal device that had sent the print job to the sender terminal device as a comparison PDL file through a network, and
the terminal device includes
a file transmitting unit that stores the PDL file of the print job in a first memory as a reference PDL file when the PDL file of the print job is transmitted to the image forming device through the network,
a file judging unit that judges whether or not the comparison PDL file returned from the image forming device matches with the reference PDL file, and
a file storing unit that stores the comparison PDL file in the first memory if the comparison PDL file does not match with the reference PDL file.

2. The image forming system according to claim 1, wherein
the file storing unit stores the comparison PDL file with current date and time in the first memory if the comparison PDL file does not match with the reference PDL file.

3. The image forming system according to claim 1, wherein
the file judging unit causes a printing executing unit of the image forming device to execute the print job if the comparison PDL file matches with the reference PDL file.

4. The image forming system according to claim 1, wherein
the terminal device further includes an error notifying unit that notifies the occurrence of a communication error to the terminal device and the image forming device if the comparison PDL file does not match with the reference PDL file.

5. The image forming system according to claim 1, wherein
the file returning unit temporarily stores the comparison PDL file in a second memory when returning the comparison PDL file, and
the file judging unit deletes the comparison PDL file temporarily stored in the second memory by the file returning unit if the comparison PDL file matches with the reference PDL file.

6. An image forming method employing an image forming system including a terminal device and an image forming device, the method comprising:
a file transmitting step including, in the terminal device, temporarily storing a PDL file of a print job as a reference PDL file in a first memory when the PDL file of the print job is transmitted to the image forming device through a network,;
a file returning step including, in the image forming device, returning the PDL file of the print job, the print job being sent from the terminal device and received by the image forming system, to the terminal device as a comparison PDL file through a network;
a file judging step including, in the terminal device, judging whether or not the comparison PDL file returned from the image forming device matches with the reference PDL file; and
a file storing step including, in the terminal device, storing the comparison PDL file in the first memory if the comparison PDL file does not match with the reference PDL file in the terminal device.
